(19) United States
(12) Patent Application Publication
(10) Pub. No.: US 2022/0323912 A1
(43) Pub. Date: Oct. 13, 2022

(54) LIQUID PURIFICATION MEMBRANE INCLUDING CARBONACEOUS MATERIALS AND METHODS OF FORMING THEM

(71) Applicant: ENTEGRIS, INC., Billerica, MA (US)

(72) Inventors: Aabid A. Mir, Bedford, MA (US); Jad A. Jaber, Westford, MA (US); Rajnikant B. Patel, Tewksbury, MA (US); Andrew Boudreau, Tewksbury, MA (US); Vinay Kalyani, Salem, NH (US)

(21) Appl. No.: 17/707,756

(22) Filed: Mar. 29, 2022

Related U.S. Application Data
(60) Provisional application No. 63/168,137, filed on Mar. 30, 2021.

(51) Int. Cl. B01D 69/14; B01D 69/02; B01D 69/12; B01D 71/02; C02F 1/44; B01D 61/14; B01D 71/44; B01D 67/00

(52) U.S. Cl. CPC B01D 69/147; B01D 69/02; B01D 69/12; B01D 71/021; C02F 1/444; B01D 61/14; B01D 71/44; B01D 67/0079; B01D 2325/04; B01D 2325/12; B01D 2325/20; B01D 2323/12; C02F 2101/10

(57) ABSTRACT

Provided are porous polymeric filter membranes comprising a polymer having admixed therein at least one carbonaceous material. The membranes are capable of removing trace amounts of various impurities from a liquid composition, including metal ions, acids, bases, and organic contaminants.

### CROSS-REFERENCE TO RELATED APPLICATIONS

This application claims the benefit under 35 USC 119 of U.S. Provisional Patent Application No. 63/168,137, filed Mar. 30, 2021, the disclosure of which is hereby incorporated herein by reference in its entirety.

### TECHNICAL FIELD

The disclosure relates generally to the field of liquid purification using membrane technology.

### BACKGROUND

Filter products are indispensable tools of modern industry, used to remove unwanted materials from a flow of a useful fluid. Useful fluids that are processed using filters include water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing.

The field of microelectronic device processing requires steady improvements in processing materials and methods to sustain parallel steady improvements in the performance (e.g., speed and reliability) of microelectronic devices. Opportunities to improve microelectronic device fabrication exist in all aspects of the manufacturing process, including methods and systems for filtering liquid materials.

A large range of different types of liquid materials are used as process solvents, cleaning agents, and other processing solutions in microelectronic device processing. Many, if not most of these materials require a very high level of purity. As an example, liquid materials (e.g., solvents) used in photolithography processing of microelectronic devices must be of very high purity. Specific examples of liquids that are used in microelectronic device processing include process solutions for spin-on-glass (SOG) techniques, for backside anti-reflective coating (BARC) methods, and for photolithography.

### SUMMARY

In summary, the disclosure relates to membranes capable of removing impurities from liquid compositions, such as alcohols and ammonium hydroxide (i.e., aqueous ammonia). The membranes are prepared by dispersing a carbonaceous material such as activated carbon within the polymer and preparing a filter membrane therefrom. The filter membranes of the disclosure are capable of removing trace amounts of certain amines and metal cations from such solutions. In one specific embodiment, the disclosure provides a membrane comprising a polymer, the polymer having admixed therein greater than zero and less than about 80 percent by weight of a carbonaceous material. The membranes are capable of providing liquid solutions of alcohols, such as C₁-C₄ alkanols, and ammonium hydroxide of extremely high purity.

### BRIEF DESCRIPTION OF THE DRAWINGS

FIG. 1 is an example of a filter component of the disclosure.

FIG. 2 is a graph of particle retention (%) versus particle loading amount (monolayer %).

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

To perform a filtration function, a filter can include a filter membrane which is responsible for removing unwanted material from a fluid which passes through the filter membrane. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

A filter membrane can be constructed of a porous structure that has average pore sizes that can be selected based on the use of the filter, i.e., the type of filtration performed by the filter. Typical pore sizes are in the micron or sub-micron range, such as from about 0.001 micron to about 10 μm. Membranes with average pore size of from about 0.001 to about 0.05 micron are sometimes classified as ultrafilter membranes. Membranes with pore sizes between about 0.05 and 10 μm are sometimes referred to as microporous membranes.

A filter membrane, or as referred to herein simply as a “membrane”, having micron or sub-micron-range pore sizes can be effective to remove an unwanted material (i.e, an impurity) from a fluid flow either by a sieving mechanism or a non-sieving mechanism, or by both. A sieving mechanism is a mode of filtration by which a particle is removed from a flow of liquid by mechanical retention of the particle at a surface of a filter membrane, which acts to mechanically interfere with the movement of the particle and retain the particle within the filter, mechanically preventing flow of the particle through the filter. Typically, the particle can be larger than pores of the filter. A “non-sieving” filtration mechanism is a mode of filtration by which a filter membrane retains a suspended particle or dissolved material contained in flow of fluid through the filter membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

Thus, in a first aspect, the disclosure provides a membrane comprising a polymer, the polymer having admixed therein greater than zero and less than about 80 percent by weight of a carbonaceous material, wherein the membrane (a) exhibits a bubble point of about 2 psi to about 200 psi when measured using ethoxy-nonafluorobutane HFE 7200 at a temperature of about 22° C., (b) an isopropanol flow time of about 20 seconds/500 ml to about 10,000 seconds/500 ml when measured at 14.2 psi, and (c) a G25 particle retention of about 25% to about 100%.

The filter comprising the membrane can be in any desired form suitable for a filtering application. Material that forms the filter can be a structural component of a filter itself and that provides the filter with a desired architecture. The filter membrane can be porous and can be of any desired shape or configuration. The filter membrane per se can be a unitary article or can be represented by a plurality of individual articles, such as particles (e.g., resin beads). The membrane is formed from a polymeric material, a mixture of different polymeric materials, or a polymeric material and a non-polymeric material. Polymeric materials that can be used to form the membranes of the disclosure include hydrophobic polymers or hydrophilic polymers. Suitable polymers include polyamides, polyimides, polyolefins, polyether-sulfones, polyacrylates, polyesters, celluloses, cellulose esters, polycarbonates, poly(phenylene oxide), poly(styrene), or combinations thereof. For example, the polymeric material of the membrane may be a hydrophobic polymer chosen from ultrahigh molecular weight polyethylenes; polyethylene; polypropylene; polymethylpentene; polybutene; polyisobutylene; copolymers of two or more of ethylene, propylene, and butylene; halogenated polymers; or combinations thereof.

In a particular embodiment, the filter membrane material includes ultra-high molecular weight polyethylene (UPE). UPE filter materials, such as UPE membranes, are typically formed from a resin having a molecular weight (weight average molecular weight) greater than about 1×10⁶ Daltons (Da), such as in the range of about 1×10⁶-9×10⁶ Da, or 1.5×10⁶-9×10⁶ Da. Crosslinking between polyolefin polymers such as polyethylene can be promoted by use of heat or crosslinking chemicals, such as peroxides (e.g., dicumyl peroxide or di-tert-butyl peroxide), silanes (e.g., trimethoxyvinylsilane), or azo ester compounds (e.g., 2,2′-azo-bis(2-acetoxy-propane).

Exemplary halogenated polymers include polytetrafluoroethylene (PTFE), polychlorotrifluoro-ethylene (PCTFE), fluorinated ethylene polymer (FEP), polyhexafluoropropylene, and polyvinylidene fluoride (PVDF).

In one embodiment, the porous filter membrane is asymmetric. In one example of an asymmetric membrane, the pore size on one face and region of the membrane is larger than on the opposing face and region. In another example, asymmetric structures can exist where the pore size on the opposing faces (and regions) of the membrane are larger while a central region of the membrane has a smaller pore size than either of the faces (e.g., an hourglass pore size profile). In other embodiments, the microporous membrane can have an essentially symmetric pore structure across its thickness (substantially the same pore size across the thickness of the membrane).

In some embodiments, the filter membrane may be a composite membrane including two or more porous polymeric membranes, which may be made from the same of different materials and/or have the same or different structure. At least one of the porous polymeric membranes of the composite membrane comprises carbonaceous material, as described herein. For example, the filter membrane can include a first porous polymeric membrane that includes the membrane(s) of the present disclosure, having a carbonaceous material, and a second filter material that does not include the membrane(s) of the present disclosure, or that is in some way different from the membrane(s) of the present disclosure, such as comprising a different polymer, a different type or amount of carbonaceous material, having a different pore structure, etc. Additional filter material layers may also be possible, with various combinations of polymers with or without carbonaceous material admixed therein, with at least one layer being a membrane of the present disclosure. As such, the composite membrane may be considered a multilayer membrane, having a first filter layer in contact with a second filter layer. As a specific example, the composite membrane can be a co-cast or co-pleated membrane of a first polymer and a second polymer, wherein one or both of these polymer layer comprises a carbonaceous material.

Accordingly, in a particular embodiment, the disclosure provides a composite filter comprising:

a first filter material and a second filter material, an outer surface of the first filter material in contact with an outer surface of the second filter material,

wherein the first filter material comprises a porous polymeric membrane comprising a polymer having admixed therein greater than zero and less than about 80 percent by weight of a carbonaceous material

and the second filter material is different from the first filter material.

The outer surface of the first filter material can be an output facing surface (in the direction of flow through the composite membrane), and the outer surface of the second filter material can be an input facing surface, or vice versa.

As used herein, a “porous polymeric membrane” is a polymeric solid that contains pores (e.g., microporous), which are interconnecting passages that extend from one surface of the membrane to an opposite surface of the membrane. The passages generally provide tortuous tunnels or paths through which a liquid to be filtered must pass. Any particles contained in this liquid that are larger than the pores are either prevented from entering the microporous membrane or are trapped within the pores of the microporous membrane (i.e., are removed by a sieving-type filtration mechanism) as fluid containing the particles passes through the membrane. Particles that are smaller than the pores are also trapped or absorbed upon interaction with the pore structure, e.g., may be removed by a non-sieving filtration mechanism.

The membranes of the present disclosure comprise carbonaceous materials distributed throughout the membrane structure. Carbonaceous materials can include, for example, activated carbon, carbon black, graphene, and carbon nanotubes. For example, activated carbons are adsorbents which can be derived from any carbonaceous precursor that may be capable of being converted to activated carbon. Examples of such carbonaceous precursors include wood, corncobs, kelp, coffee beans, rice hulls, fruit pits, peat, lignite, coconut shell, petroleum and/or coal pitch, cokes, carbon black, phenolic resin, polyvinyl chloride, etc. The morphology of the carbonaceous material admixed with the polymer of the porous polymeric membrane is not particularly critical and can be chosen from powders, particulates, fibers, sheets, etc. In one embodiment, the carbonaceous material is in a powder, a particulate, or an extruded form.

For example, the carbonaceous material can be an activated carbon, which is in the form of a solid microporous material with high surface area comprised primarily of elemental carbon and, in the case of lignin-derived carbonaceous materials, further containing small amounts of other trace elements originally found in the carbonaceous precursor materials from which the activated carbon was formed. Additionally, the activated carbon can be derived from totally synthetic (i.e., petrochemical) sources, for example polystyrene, poly(vinyl dichloride) or poly(vinyl dichloride)-methylacrylate copolymer, provided that in any case, the ultimate activated carbon surface possesses the requisite porosity so as to be effective in the method of this disclosure as taught herein. In this context, activated carbon is a microcrystalline, non-graphitic form of carbon which is processed to increase its porosity. The surface area of an activated carbon depends on its pore volume. The surface area per unit volume decreases as individual pore size increases, so surface area is maximized by increasing the number of pores of very small dimensions and/or limiting the number of pores of large dimensions. Pore sizes are defined by the International Union of Pure and Applied Chemistry as micropores (pore width <2 nm), mesopores (pore width 2-50 nm), and macropores (pore width >50 nm). Further in such activated carbon, the micropores and mesopores contribute to the adsorptive capacity of the activated carbon, whereas the macropores actually reduce the density and can be detrimental to the adsorbent effectiveness of the activated carbon, on a carbon volume basis.

In the present disclosure, in one embodiment the carbonaceous material will be in a powder or particulate form. Such carbonaceous materials can be purchased in this desired form or can be milled or jet-milled to achieve a desired particle size before addition to the polymeric material used to make the membrane. In certain embodiments, the porous polymeric membrane comprising the polymers as disclosed herein will have admixed therein greater than zero to about 80%, such as about 1 to about 60% by weight, 2 wt % to about 40 wt %, or 5 wt % to about 20 wt % of carbonaceous material. Lower levels of carbonaceous material, such as activated carbon, may be preferred in order to maintain the structural integrity or physical form of the membrane.

Further, the carbonaceous material and/or the polymer of the porous polymeric membrane will preferably have less than about 65 μg of extractible organic compounds and/or metal ions. This level of purity of the components may be achieved by cleaning with an appropriate solvent prior to formation of the membrane using techniques that would be known to one of ordinary skill in the art. Lower levels of impurities, such as less than 50 μg, would be even more preferred.

In certain embodiments, the porous polymeric membrane is in the form of a sheet or hollow fiber. In some embodiments, the sheet or hollow fiber can have any useful thickness, e.g., a thickness in a range from about 35 μm to about 400 μm, about 80 μm to about 350 μm, or about 120 μm to about 310 μm, or about 160 μm to 270 μm, or any ranges and subranges therebetween. The porous polymeric membrane sheet can be used as a flat sheet membrane or can be corrugated to form a pleated membrane.

In a specific embodiment, the carbonaceous material is an activated carbon material. Activation of carbonaceous materials may be conducted by known methods. For example, the carbonaceous material may be activated with an oxidizable chemical, such as zinc chloride, phosphoric acid, sulfuric acid, calcium chloride, sodium hydroxide, potassium bichromate, potassium permanganate or the like (chemical activation); or with steam, propane gas, exhaust gas generated from combustion gas which is a mixture of CO₂ and H₂O, carbon dioxide gas or the like (gas activation). See, for example, U.S. Pat. No. 6,589,904, incorporated herein by reference in its entirety. Alternatively, commercially available activated carbon may be utilized, for example the activated carbon products from Calgon Carbon, which are available as powders or granules. In one embodiment, after milling, the median average particle size of the activated carbon is about 30 μm to about 60 μm, or about 45 μm. In another embodiment, the activated carbon will have a surface area of greater than or equal to about 800 m²/g.

The porous polymeric membranes of the present disclosure may be made by combining the polymeric material and carbonaceous material to disperse the desired loading of carbonaceous material into the polymeric component. A dissolving or dispersing solvent may also be used for the polymer, with or without heating, as required by a given polymer. For example, a polymer such as a polysulfone, can be dissolved in a suitable solvent, such as N-methyl pyrrolidone (NMP), to which a non-solvent such as isopropanol is added to form a dope or lacquer. To this mixture, the activated carbon can be added, and the resulting mixture homogenized by vigorous stirring. The mixture can then be applied to a glass plate, followed by immersion into a non-solvent. In other words, an immersion-casting method can be used to form the porous polymeric membrane comprising admixed carbonaceous material. Alternatively, in the case of a polymer having different solubility characteristics such as high molecular weight polyethylene, such polymers can be dispersed in, for example, dioctyl phthalate (DOP) and mineral oil, along with the carbonaceous material, thus resulting in a slurry. The slurry can then be extruded into the form of a sheet, treated with various liquids to remove mineral oil and dioctyl phthalate, and allowed to dry, thereby forming the porous polymeric membrane in sheet form. In other words, once the carbonaceous material has been dispersed within the polymer matrix, the membranes of the present disclosure can be prepared using known temperature induced (TIPS) or solvent induced phase separation (SIPS) processes used in the forming of polymeric sheets comprising thermoplastic polymers.

Thus, in a further aspect, the disclosure provides a method for preparing a porous polymeric membrane in the form of a sheet for the filtration of liquids comprising organic and metal ion impurities, wherein the porous polymeric membrane comprises a polymer having a carbonaceous material, such as an activated carbon, dispersed therein, which comprises the steps:
combining the carbonaceous material and a flowable form of the polymer, wherein the polymer has been either (i) admixed with an effective amount of at least one solvent and/or dispersant to provide the flowable form; and/or (ii) heated to a temperature sufficient to provide the flowable form;
physically dispersing the carbonaceous material into the polymer, thereby providing a polymer composition having carbonaceous material dispersed therein; and
removing the solvent or dispersant from the polymer composition when present, and/or cooling the polymer composition while casting or extruding into a sheet;
wherein the porous polymeric membrane is capable of removing up to about 60% to about 100% percent of amine contaminants, and about 75% to about 95% percent of metal ion contaminants from the liquids.

In one embodiment of this method, the polymer is chosen from polyamides, polyimides, polyolefins, polyether-sulfones, polyacrylates, polyesters, celluloses, cellulose esters, polycarbonates, poly(phenylene oxide), poly(styrene), or combinations thereof. In another embodiment, the polymer is chosen from ultrahigh molecular weight polyethylenes; polyethylene; polypropylene; polymethylpentene; polybutene; polyisobutylene; copolymers of two or more of ethylene, propylene, and butylene; polytetrafluoroethylene; polychlorotrifluoro-ethylene; fluorinated ethylene polymer; polyhexafluoropropylene; polyvinylidene fluoride; polyamides; polyimides; polysulfones; polyether-sulfones; polyarylsulfones; polyacrylates; polyesters; nylons; celluloses; cellulose esters; polycarbonates; polysulfones; poly(phenylene oxide); poly(styrene); or combinations thereof.

Referring to the porous polymeric filter membranes as described herein, such membranes can be characterized by physical features that include pore size, bubble point, and porosity. In this regard, the porous polymeric filter membrane may have any pore size that will allow the filter membrane to be effective for performing as a filter membrane, e.g., as described herein, including pores of a size (average pore size) sometimes considered as a microporous filter membrane or an ultrafilter membrane. Examples of useful porous polymeric membranes have an average pore size in a range on from about 0.001 μm to about 1 or 2 μm, e.g., from 0.01 to 0.8 μm, with the pore size be selected based on one or more factors that include: the particle size or type of impurity to be removed, pressure and pressure drop requirements, and viscosity requirements of a liquid being processed by the filter. An ultrafiltration membrane can have an average pore size in a range from 0.001 μm to about 0.05 μm. Pore size is often reported as average pore size of a porous material, which can be measured by known techniques such as by Mercury Porosimetry (MP), Scanning Electron Microscopy (SEM), Liquid Displacement (LLDP), or Atomic Force Microscopy (AFM).

Bubble point is also a known feature of a porous membrane. By a bubble point test method, a sample of porous polymeric filter membrane is immersed in and wetted with a liquid having a known surface tension, and a gas pressure is applied to one side of the sample. The gas pressure is gradually increased. The minimum pressure at which the gas flows through the sample is called a bubble point. As a specific method to determine the bubble point of a porous polymeric material, a sample of the porous material is immersed in and wetted with ethoxy-nonafluorobutane HFE 7200 (available from 3M) at a temperature of 20-25° C. (e.g., 22° C.). A gas pressure is applied to one side of the sample by using compressed air and the gas pressure is gradually increased. The minimum pressure at which the gas flows through the sample is called the bubble point. All bubble point values provided herein are measured using this procedure. Examples of useful or preferred bubble point values of a porous polymeric filter membrane according to the present description, measured using the procedure described above, can be in a range from about 2 to about 200 psi, about 2 to about 150 psi, about 2 to about 100 psi, about 10 to about 200 psi, about 10 to about 150 psi, about 10 to about 100 psi, about 10 to about 40 psi, about 20 to about 200 psi, about 20 to about 150 psi, about 20 to about 100 psi, about 40 to about 200 psi, about 40 to about 150 psi, about 40 to about 100 psi, about 60 to about 200 psi, about 60 to about 150 psi, about 60 to about 100 psi, about 80 to about 200 psi, about 80 to about 150 psi, about 100 to about 200 psi, about 100 to about 150 psi, about 150 to about 200 psi, or any and all ranges therebetween. A porous polymeric filter membrane as described may have any porosity that will allow the porous polymeric filter membrane to be effective as described herein. Example porous polymeric membranes can have a relatively high porosity, for example a porosity of at least 60, 70 or 80 percent. As used herein, and in the art of porous bodies, a “porosity” of a porous body (also sometimes referred to as void fraction) is a measure of the void (i.e., “empty”) space in the body as a percent of the total volume of the body and is calculated as a fraction of the volume of voids of the body over the total volume of the body. A body that has zero percent porosity is completely solid.

A porous polymeric filter membrane of the present disclosure can be useful with any type of industrial or life sciences process that requires a high purity liquid material as an input. Non-limiting examples of such processes include processes of preparing microelectronic or semiconductor devices, a specific example of which is a method of filtering a liquid process material (e.g., solvent or solvent-containing liquid) used for semiconductor photolithography. Examples of contaminants present in a process liquid or solvent used for preparing microelectronic or semiconductor devices may include metal ions dissolved in the liquid, solid particulates suspended in the liquid, and gelled or coagulated materials (e.g., generated during photolithography) present in the liquid.

As discussed above, the porous polymeric membranes can be a single layer or may be a multilayer, being combined with another filter material to form a composite filter membrane. In either case, the filter membrane can be useful to remove a dissolved or suspended contaminant or impurity from a liquid that is caused to flow through the filter membrane, either by a sieving mechanism or a non-sieving mechanism, and preferably by both a combined non-sieving and a sieving mechanism.

Such porous polymeric membranes have been found to be useful in the removal of metal ion contaminants along with organic contaminants such as amines to provide liquid compositions of exceptionally high purity. Exemplary liquid compositions are materials such as organic solvents, for example alcohols and ketones, and dissolved aqueous ammonia, i.e., NH₄OH. In this regard, reference to aqueous ammonia, or simply “ammonia” is understood to refer to an aqueous NH₄OH solution with any concentration of ammonia therein. Thus, in a further aspect, the disclosure provides a purified liquid composition comprising one or more ketones or alcohols, wherein the purified composition contains no more than about 2000 ppb of organic amine impurities. In one embodiment, the organic amine impurities are chosen from triethylamine, N,N-diisopropylamine, heptylamine, and 3,3,5,5-tetramethyl benzylidene. In another embodiment, the alcohols are C₁-C₄ alcohols, such as isopropanol.

In addition, various metal impurities may also be removed by the porous polymeric membranes described herein. In certain embodiments, the resulting purified liquid composition comprises no greater than about 12 ppb total of metal ions, such as cations of magnesium, aluminum, titanium, vanadium, manganese, nickel, copper, zinc, molybdenum, silver, cadmium, tin, and lead.

In one particular embodiment, the purified liquid composition comprises no less than 99.99 weight percent of isopropanol, the composition comprises no more than about 2000 ppb total of amines and no more than about 12 ppb total of metal ions. In another embodiment, the purified liquid composition comprises NH₄OH, wherein the composition contains no more than about 2000 ppb of impurities chosen from triethyl amine, isopropylamine, heptylamine, N, N-diisopropylethylamine, and tetramethylbenzylidine.

Thus, the porous polymeric membranes of the present disclosure enable processes or methods for the filtration or purification of various liquid and organic compositions. Accordingly, in another aspect, the disclosure provides a method of preparing a purified liquid composition, the composition comprising (a) one or more ketones or alcohols, or (b) aqueous ammonia. In one embodiment, the composition contains no more than 2000 ppb of impurities chosen from one or more of triethylamine, N,N-diisopropylamine, heptylamine, N,N-diisopropylethylamine, and 3,3,5,5-tetramethylbenzylidine. This purified composition can be obtained by a method comprising exposing a liquid composition in need of purification, comprising (i) one or more ketones or alcohols or (ii) NH₄OH, and at least one organic amine impurity chosen from one or more of triethylamine, N,N-diisopropylamine, heptylamine, and N,N-diisopropylethylamine, and 3,3,5,5-tetramethyl benzylidene, to one or more of the porous polymeric membranes of the present disclosure. In one embodiment, the purified composition comprises no less than about 99.99 weight percent of the ketone or alcohol (such as isopropanol), or of the aqueous ammonia. The exposure to the porous polymeric membranes can be accomplished either by actively passing the liquid composition through the membrane or merely submerging the membrane into the liquid composition to be purified. In another embodiment, the purified compositions comprise no more than 12 ppb total of metal ions.

Thus, the porous polymeric filter membranes as described herein can be used to purify various types of liquid compositions, such as liquid chemicals (including solvents) that are used or are useful in a semiconductor or microelectronic fabrication applications. For example, the liquid composition may comprise a liquid chemical or combinations of liquid chemicals along with one or more impurities, optionally further comprising various additional components, such as a polymeric material used for a photoresist. The porous polymeric filter membranes of the present disclosure can effectively remove all or a significant portion of the impurities (i.e., unwanted species) from the liquid compositions. Examples of suitable liquid chemicals include, but are not limited to, methyl-amyl ketone, ethyl-3-ethoxypropionate, propylene glycol methyl ether (PGME), propylene glycol methylethylacetate (PGMEA), a mixed solution of propylene glycol monomethyl ether (PGME) and PGMEA (such as 7:3), methanol, ethyl acetate, ethyl lactate, and combinations thereof. Additional examples include organic amines such as hydroxylamine, monoethanolamine (MEA), triethanolamine (TEA), morpholine, N-methyldiethanolamine (MDEA), N-monomethylethanolamine (MMEA), N-ethylaminoethoxyethanol, 2-(2-aminoethoxy)ethanol), tetraethylammonium hydroxide (TEAH), tetrabutylammonium hydroxide (TBAH), and combinations thereof. Further examples of liquid chemicals from which impurities may be removed by the porous polymeric filter membranes of the present disclosure include n-butyl acetate (nBA), isopropyl alcohol (IPA), 2-ethoxyethyl acetate (2EEA), a xylene, cyclohexanone, methyl isobutyl carbinol (MIBC), methyl isobutyl ketone (MIBK), isoamyl acetate, and undecane. Other process liquids, such as deionized water, hydrogen peroxide, hydrochloric acid, sulfuric acid, and mixtures thereof may also be purified using the porous polymeric membranes described herein. Thus, using the disclosed membranes, impurities such as metal ions and/or organic impurities, such as fluorinated organic compounds, can be removed from liquid compositions such as acids, bases, peroxides, liquid chemicals (including those containing polymers), and mixtures thereof.

Thus, the membranes of the present disclosure are capable of purifying certain liquid compositions as described herein to provide extremely pure compositions, which, after filtration, possess amounts of impurities, such as amine/organic and metal ion contaminants, which approach the limits of detection. Therefore, in a further aspect, the present disclosure provides a purified liquid composition, the composition comprising:
a) one or more ketones or alcohols, or
b) aqueous ammonia,
   wherein the composition contains no more than 2000 ppb of impurities chosen from one or more of triethylamine, isopropylamine, heptylamine, N,N-diisopropylethylamine, and tetramethylbenzylidine,
   the composition obtained by exposing a liquid composition in need of purification comprising
i) one or more ketones or alcohols or
ii) aqueous ammonia, and at least one amine impurity chosen from one or more of triethylamine, isopropyl amine, N,N-diisopropylamine, heptylamine, and 3,3,5,5-tetramethyl benzylidene,

to one or more porous polymeric membranes of the disclosure as set forth herein.

Retention Test

“Particle retention” or “coverage” refers to the percentage of the number of particles that can be removed from a fluid stream by a membrane placed in the fluid pathway of the fluid stream. Particle retention determined according to the following procedure is referred to as the “G25 particle retention”. Particle retention of a 47 mm membrane disc can be measured by passing a sufficient amount of an aqueous feed solution of 0.1% Triton X-100 having a pH of about 5, containing 8 ppm polystyrene particles having a nominal diameter of 0.03 μm (available from Duke Scientific G25B), to achieve 1% monolayer coverage through a membrane at a constant flow of 7 mL/min, and collecting the permeate. The G25 particle retention is taken to be determined with a 1% monolayer unless otherwise specified. The concentration of the polystyrene particles in the permeate can be calculated from the absorbance of the permeate. Particle retention is then calculated using the following equation:

$$particle retention = \frac{[ feed ] - [ filtrate ]}{[ feed ]} \times 100 \%$$

The number (#) of particles necessary to achieve 1% monolayer coverage can be calculated from the following equation:

$$\# of particles for n \% monolayer = \frac{a}{( \frac{\sqrt{3}}{2} ) {( dp )}^{2}} \times \frac{n}{100}$$

wherein:
a=effective membrane surface area
dₚ=diameter of the particle
n=the % monolayer

“Nominal diameter” as used herein, is the diameter of a particle as determined by photon correlation spectroscopy (PCS), laser diffraction or optical microscopy. Typically, the calculated diameter, or nominal diameter, is expressed as the diameter of a sphere that has the same projected area as the projected image of the particle. PCS, laser diffraction and optical microscopy techniques are well-known in the art. See, for example, Jillavenkatesa, A., et al.; “Particle Size Characterization;” NIST Recommended Practice Guide; National Institute of Standards and Technology Special Publication 960-1; January 2001.

In some embodiments, the G25 particle retention is in a range from about 25% to about 100%, about 25% to about 99%, about 25% to about 97%, about 25% to about 95%, about 25% to about 90%, about 25% to about 85%, 50% to about 100%, about 50% to about 99%, about 50% to about 97%, about 50% to about 95%, about 50% to about 90%, about 50% to about 85%, about 70% to about 100%, about 70% to about 99%, about 70% to about 97%, about 70% to about 95%, about 70% to about 90%, about 70% to about 85%, 75% to about 100%, about 75% to about 99%, about 75% to about 97%, about 75% to about 95%, about 75% to about 90%, about 75% to about 85%, 80% to about 100%, about 80% to about 99%, about 80% to about 97%, about 80% to about 95%, about 80% to about 90%, about 80% to about 85%, 85% to about 100%, about 85% to about 99%, about 85% to about 97%, about 85% to about 95%, about 85% to about 90%, or all ranges and subranges therebetween.

In some embodiments, the membranes disclosed herein have a G25 particle retention (i.e., at 1% monolayer) in one of the ranges disclosed above and also have a G25 particle retention with a 5% monolayer in a range from about 60% to about 80%, about 60% to about 75%, about 60% to about 70%, about 65% to about 80%, about 65% to about 75%, about 70% to about 80%, or all ranges and subranges therebetween.

A filter membrane as described herein, can have a relatively low flow time, preferably in combination with a bubble point that is relatively high, and good filtering performance (e.g., as measured by particle retention, dye-binding capacity, or both). An example of a useful or preferred isopropanol flow time can be below about 20,000 seconds/500 mL, e.g., below about 4,000 or 2,000 seconds/500 mL

Membrane isopropanol (IPA) flow times as reported herein can be determined by measuring the time it takes for 500 ml of isopropyl alcohol (IPA) fluid to pass through a membrane with a 47 mm membrane disc with an effective surface area of 13.8 cm², at 14.2 psi, and at a temperature of 21° C. In some embodiments, the flow time is in a range of about 20 seconds/500 ml to about 10,000 seconds/500 ml, about 20 seconds/500 ml to about 5,000 seconds/500 ml, about 20 seconds/500 ml to about 1,000 seconds/500 ml, about 20 seconds/500 ml to about 800 seconds/500 ml, about 20 seconds/500 ml to about 500 seconds/500 ml, about 100 seconds/500 ml to about 10,000 seconds/500 ml, about 100 seconds/500 ml to about 5,000 seconds/500 ml, about 100 seconds/500 ml to about 1,000 seconds/500 ml, about 100 seconds/500 ml to about 800 seconds/500 ml, about 100 seconds/500 ml to about 500 seconds/500 ml, about 500 seconds/500 ml to about 10,000 seconds/500 ml, about 500 seconds/500 ml to about 5,000 seconds/500 ml, about 500 seconds/500 ml to about 1,000 seconds/500 ml, about 500 seconds/500 ml to about 800 seconds/500 ml, about 845 seconds/500 ml to about 10,000 seconds/500 ml, about 845 seconds/500 ml to about 5,000 seconds/500 ml, about 845 seconds/500 ml to about 1,665 seconds/500 ml, about 845 seconds/500 ml to about 1000 seconds/500 ml, about 1,000 seconds/500 ml to about 10,000 seconds/500 ml, about 1,000 seconds/500 ml to about 5,000 seconds/500 ml, about 20 seconds/500 ml to about 2,500 seconds/500 ml, or all ranges and subranges therebetween.

In certain embodiments, the membranes described herein can be approximately equal to or greater than a flow time of the same filter membrane that does not contain the carbonaceous material. In other words, admixing of the carbonaceous material does not have a substantial negative impact on the flow properties of the filter membrane, yet still improve the filtering function of the filter membrane, especially the non-sieving filtering function of the membrane, e.g., as measured by dye-binding capacity, particle retention, or both, depending on the pore size.

The porous polymeric filter membrane as described herein can be contained within a larger filter structure, such as a multilayer filter assembly or a filter cartridge that is used in a filtering system. The filtering system will place the filter membrane, e.g., as part of a multi-layer filter assembly or as part of a filter cartridge, in a filter housing to expose the filter membrane to a flow path of a liquid composition to cause at least a portion of the flow of the liquid composition to pass through the porous polymeric filter membrane comprising a carbonaceous material, so that the filter membrane removes an amount of the impurities or contaminants from the liquid composition. The structure of a multi-layer filter assembly or filter cartridge may include one or more of various additional materials and structures that support the filter membrane within the filter assembly or filter cartridge to cause fluid to flow from a filter inlet, through the membrane (including the filter layer), and thorough a filter outlet, thereby passing through the filter membrane when passing through the filter. The filter membrane supported by the filter assembly or filter cartridge can be in any useful shape, e.g., a pleated cylinder, a cylindrical pad, one or more non-pleated (flat) cylindrical sheets, a pleated sheet, among others.

One particular example of a filter structure that includes a porous polymeric filter membrane in the form of a pleated cylinder can be prepared to include the following component parts, any of which may be included in a filter construction but may not be required: a rigid or semi-rigid core that supports an interior of the pleated cylindrical porous polymeric filter membrane; a rigid or semi-rigid cage that supports or surrounds an exterior of the pleated cylindrical coated filter membrane at an exterior of the filter membrane; optional end pieces or “pucks” that are situated at each of the two opposed ends of the pleated cylindrical coated filter membrane; and a filter housing that includes an inlet and an outlet. The filter housing can be of any useful and desired size, shape, and materials, and can preferably be made of suitable polymeric material.

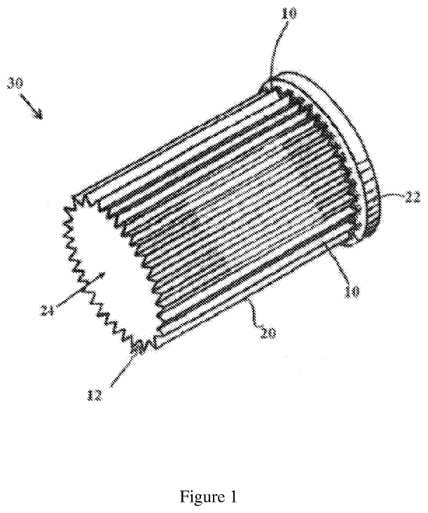

As one example, FIG. 1 shows filter component 30, which is a product of pleated cylindrical component 10 and end piece 22, with other optional components. Cylindrical component 10 includes a filter membrane 12, as described herein, and is pleated. End piece 22 is attached (e.g., “potted”) to one end of cylindrical filter component 10. End piece 22 can preferably be made of a melt-processable polymeric material. A core (not shown) can be placed at the interior opening 24 of pleated cylindrical component 10, and a cage (not shown) can be placed about the exterior of pleated cylindrical component 10. A second end piece (not shown) can be attached (“potted”) to the second end of pleated cylindrical component 10. The resultant filter component 30 with two opposed potted ends and optional core and cage can then be placed into a filter housing that includes an inlet and an outlet and that is configured so that an entire amount of a fluid entering the inlet must necessarily pass through filter membrane 12 before exiting the filter at the outlet.

### EXAMPLES

### Example 1: Preparation of a Porous Polymeric Membrane Comprising Ultrahigh Molecular Weight Polyethylene (UPE) and Activated Carbon

A 15% (w/w) dispersion of UPE (ultrahigh molecular weight polyethylene) in a mixture of DOP (dioctyl phthalate) and mineral oil was prepared at room temperature, and to this mixture was added 5% (w/w) powdered activated carbon. The UPE polymer has a mean particle size of about 120 μm. The mineral oil has a viscosity of 68 CP at 40° C. and a specific gravity of 0.86 at 25° C. The three-component mixture, which has a consistency of a viscous slurry, was fed into a Brabender twin-screw mixed/extruder with a pair of 42 mm slotted counterrotating screws L/D-(7:1). A Zenith gear pump, and a 5″ wide die was also attached to the extruder for extrusion of the melt blend into sheet form. The temperatures of the various extrusion zones were set at between 180° C. to 260° C. The volumetric output of melt blend from the extruder was 46 cc/min. The extruded film was quenched on a rotating chrome plated chill roll where temperature was controlled at 90° C. by circulating constant temperature fluid through it. The quenched film was rolled up at a speed of approximately 6 ft/min by a motorized winder and interleaved with a highly porous light weight polypropylene spunbonded non-woven fabric material. To extract the mineral oil from the quenched gel membrane, the interleaved roll was placed into metal frames and clamped with clips and the frames were placed in a Baron-Blakslee degreaser containing hydrofluoroethane (HFE) for reflux extraction. The extraction time was between 12-24 hrs. It was then dried at room temperature to remove the extractant and further heat-set at 100° C. for 5 minutes. During drying and heat-setting, the membrane was restrained by material wound upon itself. This helps to prevent the membrane from experiencing excessive shrinkage.

This general procedure may also be used to prepare other loading levels of activated carbon, for example 20% or 50% (w/w). The isolated porous polymeric UPE membranes containing 5, 20 and 50% (w/w) activated carbon were found to have the IPA (isopropanol) flow time and bubble point values shown in Table 1, using the methods described above.

TABLE 1

| | Bubble Point | IPA Flow | Thickness |
|---|---|---|---|
| Sample | (psi) | (sec/500 ml) | (um) |
| 5% activated carbon in UPE | 30 | 1830 | 95 |
| 20% activated carbon in UPE | 35 | 2417 | 100 |
| 50% activated carbon in UPE | 10 | 845 | 85 |
| 50% activated carbon in UPE | 26 | 694 | 150 |
| 60% activated carbon in UPE | 40 | 1450 | 160 |
| UPE | 30 | 810 | 110 |

### Example 2: Preparation of a Porous Polymeric Membrane Comprising Polysulfone and Activated Carbon

A 12% (w/w) polyphenylsulfone (PPSU) resin with M_{w}=50,700 Da was dissolved in N-methyl-2-pyrrolidone (NMP) at room temperature. To this solution was slowly added isopropyl alcohol (IPA) to form a dope (lacquer) solution. To the resulting mixture was added 5% to 10% (w/w) of powdered activated carbon, which was dispersed into the mixture with a handheld homogenizer for 5-10 minutes. The resulting dope mixture was then coated on a glass plate using a 7 mil knife, and the porous polysulfone membranes comprising admixed activated carbon were isolated by immersion casting into a non-solvent.

### Example 3: Determination of Filter Retention of G25 Beads for Porous UPE Membranes Comprising Activated Carbon

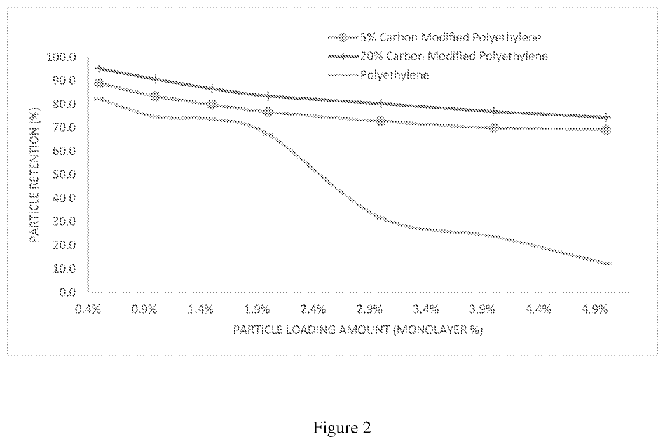

The G25 particle retention was determined using the method described above (at pH 5) for a UPE membrane. An ultrahigh molecular weight polyethylene membrane comprising admixed activated carbon was prepared using the method described in Example 1. The G25 particle retention was calculated for 0.5, 1, 1.5, 2, 3, 4 and 5% monolayer. The porous UPE membrane comprising admixed activated carbon demonstrated improved G25 bead retention when compared to a porous UPE membrane without activate carbon. With a loading of 5% and 20% activated carbon, the bead retention has increased compared to a porous UPE membrane not comprising activated carbon. The results are depicted in the Table 2 and are plotted in FIG. 2.

TABLE 2
G25 Particle Retention

| | 5% Activated | 20% Activated | UPE |
|---|---|---|---|
| | Carbon in UPE | Carbon in UPE | control |
| 0.5% monolayer | 88.9% | 95.2% | 82.2% |
| 1% monolayer | 83.4% | 90.6% | 74.8% |
| 1.5% monolayer | 79.9% | 86.6% | 73.7% |
| 2% monolayer | 76.8% | 83.5% | 67.3% |
| 3% monolayer | 72.9% | 80.3% | 31.7% |
| 4% monolayer | 70.0% | 76.9% | 23.8% |
| 5% monolayer | 69.2% | 74.5% | 12.3% |

### Example 4: Determination of Organic Removal in IPA Using Porous UPE Membranes Comprising Activated Carbon

The following example demonstrates organic impurities removal from isopropyl alcohol (IPA) by activated carbon containing UPE membranes. Porous UPE membranes comprising activated carbon were prepared using a method similar to that shown in Example 1 and were then cut into 47 mm membrane coupons. To determine the filtration organic removal efficiency, the membrane coupons were immersed in the IPA solution, spiked with organic impurities (2 ppm of each contaminant). The removal efficiencies were determined using GC-MS. The results are depicted in Organic Removal (%) in Table 3:

TABLE 3
Static Organic Removal Efficiencies in isopropanol (IPA)
Percent Removal from IPA

| | 20% activated | 50% activated | UPE |
|---|---|---|---|
| Contaminant | carbon in UPE | in UPE | control |
| Triethylamine | 29 | 70 | 0 |
| N,N-Diisopropylethylamine | 16 | 50 | 0 |
| Heptylamine | 50 | 100 | 0 |
| Tetramethylbenzylidine (TMB) | 100 | 100 | 5 |
| Dodecene | 5 | 60 | 0 |
| C10H22 | 0 | 8 | 0 |
| C11H24 | 0 | 21 | 0 |
| C12H26 | 0 | 20 | 0 |
| C13H28 | 2 | 50 | 0 |
| C14H30 | 0 | 46 | 0 |
| C15H32 | 0 | 67 | 0 |
| C16H34 | 7 | 79 | 0 |
| C17H36 | 9 | 82 | 0 |
| C18H38 | 19 | 92 | 0 |
| C19H40 | 28 | 95 | 0 |
| C20H42 | 37 | 97 | 2 |
| C21H44 | 51 | 98 | 7 |
| C22H46 | 60 | 99 | 6 |
| C23H48 | 73 | 100 | 13 |
| C24H50 | 80 | 99 | 15 |
| C25H52 | 88 | 100 | 24 |
| C26H54 | 92 | 99 | 34 |
| C27H56 | 95 | 100 | 46 |
| C28H58 | 97 | 100 | 56 |
| C29H60 | 99 | 100 | 70 |
| C30H62 | 99 | 100 | 80 |

As shown, the porous UPE membranes comprising activated carbon show efficient organic removal compared to the UPE Control. Amine-based impurities, such as tetramethylbenzylidine (TMB) and heptylamine, are removed by 100% using 50% carbon modified membranes. The same impurities are not removed by the non-activated carbon containing UPE membrane. Similarly, large chain hydrocarbons are also being removed efficiently (>95%) compared to the UPE alone.

### Example 5: Determination of Organic Removal in 29% Ammonia Using Porous UPE Membranes Containing Activated Carbon

The following example demonstrates organic impurities removal from a 29% ammonia solution. UPE membranes containing admixed activated carbon were prepared using the method like the example 1 and cut into 47 mm membrane coupons. To determine the filtration organic removal efficiency, the membrane coupons were immersed in the 29% ammonia solution, spiked with organic impurities and the static soak tests were run for 24 hrs. The removal efficiencies were determined using LC-QToF and shown in Table 4:

TABLE 4
Organic Removal from Ammonia
Percent Removal from Ammonia

| | 5% activated | 20% activate | 50% activated | UPE |
|---|---|---|---|---|
| Contaminant | carbon in UPE | carbon in UPE | carbon in UPE | control |
| Triethylamine | 0 | 53 | 100 | 16 |
| N,N-Diisopropylethylamine | 76 | 100 | 100 | 63 |
| Heptylamine | 84 | 100 | 100 | 35 |
| Tetramethylbenzidine (TMB) | 100 | 100 | 100 | 46 |

As shown, the porous UPE membranes comprising activated carbon removed all of the target impurities from ammonia compared to the porous UPE membrane not comprising activated carbon. The removal efficiencies are increased as the amount of activated carbon is increased in the membranes.

### Example 6: Determination of Metal Removal from IPA Using Porous UPE Membranes Comprising Activated Carbon

The following example is a general example that demonstrates metal removals by UPE membranes from organic solvents, such as isopropyl alcohol (IPA), propylene glycol methyl ether (PGME), (2-methoxy-1-methylethylacetate), propylene glycol monomethyl ether acetate (PGMEA), OK73™ (a 70/30 blend of propylene glycol methyl ether acetate/propylene glycol methyl ether (PGMEA/PGME)), and cyclohexanone.

Porous UPE membranes comprising activated carbon were prepared using a method similar to that shown in Example 1, and the membranes were then cut into 47 mm diameter discs (coupons). The membranes were first washed several times with 10% HCl followed by rinsing with DI water and finally soaking in 10% HCl overnight and equilibrated with deionized water. For each solvent, a 47 mm coupon was immersed in the solution spiked with an aqueous metal standard that contained 21 to 28 metals (SCP Science) to achieve a target concentration of 5 ppb of each total metal. The feed and the filtrate samples were then analyzed by an Agilent Model 8800 ICP-MS (Inductively Coupled Plasma-Mass Spectroscopy) to determine the membrane's ability to remove metal ion from these solvents. Results are shown in Tables 5-9.

TABLE 5
Determination of Metal Removal from IPA using a Porous UPE Membrane
Comprising Activate Carbon
IPA (Percent Removal)

| | UPE | 20% Activated |
|---|---|---|
| | control | Carbon in UPE |
| Li | 0% | 0% |
| Be | 0% | 0% |
| Na | 0% | 0% |
| Mg | 6% | 83% |
| Al | 0% | 78% |
| K | 0% | 0% |
| Ca | 1% | 0% |
| Ti | 60% | 76% |
| V | 1% | 0% |
| Cr | 0% | 12% |
| Mn | 0% | 88% |
| Fe | 0% | 0% |
| Co | 34% | 57% |
| Ni | 0% | 87% |
| Cu | 15% | 88% |
| Zn | 12% | 80% |
| Ge | 13% | 53% |
| As | 10% | 9% |
| Sr | 12% | 40% |
| Mo | 18% | 93% |
| Ag | 8% | 96% |
| Cd | 10% | 96% |
| In | 28% | 44% |
| Sn | 22% | 83% |
| Sb | 5% | 14% |
| Ba | 51% | 67% |
| Ta | 1% | 1% |
| W | 15% | 25% |
| Pb | 7% | 94% |

TABLE 6
Determination of Metal Removal from PGMEA using a Porous
UPE Membrane Comprising Activated Carbon
PGMEA (Percent Removal)

| | UPE | 20% Activated |
|---|---|---|
| | control | Carbon in UPE |
| Li | 0% | 7% |
| Na | 0% | 38% |
| Mg | 71% | 94% |
| Al | 74% | 88% |
| K | 0% | 0% |
| Ca | 0% | 0% |
| Ti | 33% | 75% |
| V | 11% | 88% |
| Cr | 0% | 16% |
| Mn | 0% | 89% |
| Fe | 0% | 0% |
| Ni | 5% | 91% |
| Cu | 1% | 90% |
| Zn | 18% | 100% |
| Mo | 0% | 73% |
| Ag | 3% | 86% |
| Cd | 33% | 92% |
| Sn | 0% | 86% |
| Ba | 90% | 76% |
| Pb | 4% | 96% |

TABLE 7
Determination of Metal Removal from PGME using a Porous
UPE Membrane Comprising Activated Carbon
PGME (Percent Removal)

| | UPE | 20% Activated |
|---|---|---|
| | control | Carbon in UPE |
| Li | 0% | 0% |
| Be | 0% | 50% |
| Na | 0% | 0% |
| Mg | 23% | 38% |
| Al | 0% | 0% |
| K | 0% | 0% |
| Ca | 0% | 0% |
| Ti | 0% | 46% |
| V | 4% | 44% |
| Cr | 0% | 2% |
| Mn | 29% | 0% |
| Fe | 0% | 0% |
| Ni | 6% | 0% |
| Co | 0% | 0% |
| Cu | 24% | 41% |
| Zn | 0% | 93% |
| Ge | 0% | 0% |
| As | 19% | 0% |
| Sr | 0% | 0% |
| Mo | 0% | 94% |
| Ag | 0% | 99% |
| Cd | 5% | 98% |
| In | 0% | 0% |
| Sn | 7% | 79% |
| Sb | 100% | 0% |
| Ba | 29% | 42% |
| Ta | 0% | 0% |
| W | 51% | 80% |
| Tl | 0% | 0% |
| Pb | 12% | 33% |

TABLE 8
Determination of Metal Removal from OK73 using a Porous
UPE Membrane Comprising Activated Carbon
OK73 ™ (Percent Removal)

| | UPE | 20% Activated |
|---|---|---|
| | control | Carbon in UPE |
| Li | 0% | 0% |
| Be | 4% | 0% |
| Na | 0% | 0% |
| Mg | 10% | 54% |
| Al | 5% | 22% |
| K | 0% | 0% |
| Ca | 0% | 0% |
| Ti | 0% | 66% |
| V | 0% | 34% |
| Cr | 0% | 0% |
| Mn | 5% | 0% |
| Fe | 0% | 0% |
| Ni | 7% | 0% |
| Co | 0% | 0% |
| Cu | 0% | 99% |
| Zn | 0% | 87% |
| Ge | 0% | 21% |
| As | 10% | 0% |
| Sr | 17% | 41% |
| Mo | 0% | 77% |
| Ag | 0% | 100% |
| Cd | 0% | 98% |
| In | 0% | 0% |
| Sn | 0% | 48% |
| Sb | 5% | 0% |
| Ba | 13% | 49% |
| Ta | 100% | 100% |
| W | 25% | 0% |
| Tl | 0% | 0% |
| Pb | 0% | 75% |

TABLE 9
Determination of Metal Removal from Cyclohexanone using a Porous UPE
Membrane Comprising Activated Carbon
CYCLOHEXANONE (Percent Removal)

| | | 20% Activated |
|---|---|---|
| | UPE control | Carbon in UPE |
| Li | 0% | 0% |
| Na | 15% | 0% |
| Mg | 8% | 55% |
| Al | 24% | 15% |
| K | 1% | 0% |
| Ca | 0% | 0% |
| Ti | 29% | 76% |
| V | 24% | 100% |
| Cr | 0% | 39% |
| Mn | 0% | 58% |
| Fe | 0% | 0% |
| Ni | 7% | 63% |
| Cu | 30% | 95% |
| Zn | 17% | 100% |
| Mo | 5% | 99% |
| Ag | 3% | 92% |
| Cd | 29% | 100% |
| Sn | 14% | 72% |
| Ba | 39% | 94% |
| Pb | 29% | 100% |

The porous polymeric membranes comprising activated carbon were tested for metal removal efficiency using S21 and S28 metal standard from Inorganic Ventures. As shown, better removal of metals was found by carbon containing membranes from organic solvents compared to the aqueous solutions. Metal removal using 20% (w/w) activated carbon containing UPE membranes have demonstrated high removal efficiency (>80%) in most organic solvents compared to the aqueous solutions, particularly for metals such as copper (Cu), zinc (Zn), molybdenum (Mo), silver (Ag), cadmium (Cd), and lead (Pb).

### Example 7: Determination of Metal Removal from Dilute Peroxide and DIW

This example demonstrates the ability of porous polymeric membranes comprising activated carbon to reduce metals in solvents such as dilute hydrogen peroxide and deionized water (DIW) under static soaking conditions.

Porous UPE membranes comprising activated carbon (0.2 μm), prepared as described above, were cut into 47 mm discs. These membrane discs were then conditioned by washing several times with 10% HCl and 70% IPA, followed by immersion in 10% HCl overnight, equilibrating with deionized water and drying at room temperature. Inorganic ventures (IV-62491) standard metals were spiked into the above solvents at a target concentration of 5 ppb for each metal. To determine the metal removal efficiency of static immersion, 20 mL of metal spiked solvent solutions were placed in a PFA bottle with a dry 47 mm membrane disc and spun for 18 hours. After 18 hours, the membrane discs were removed, and the metal concentration of the metal-spike containing solvents and each solvent film supernatant sample was determined using ICP-MS. The results are shown in Table 10.

TABLE 10
Percent Removal from DIW and Dilute Peroxide

| | Percent Removal | Percent removal |
|---|---|---|
| Spiked Metals | from DIW | from 1% H2O2 |
| Li | 0% | 0% |
| Be | 29% | 11% |
| Na | 0% | 0% |
| Mg | 0% | 0% |
| Al | 0% | 0% |
| K | 0% | 0% |
| Ca | 0% | 0% |
| Ti | 46% | 84% |
| V | 88% | 38% |
| Cr | 0% | 0% |
| Mn | 0% | 0% |
| Fe | 0% | 20% |
| Co | 1% | 22% |
| Ni | 0% | 0% |
| Zn | 0% | 0% |
| Cu | 0 | 0% |
| Ge | 39% | 38% |
| As | 87% | 0% |
| Sr | 41% | 53% |
| Mo | 95% | 99% |
| Ag | 99% | 98% |
| Cd | 36% | 36% |
| In | 0% | 27% |
| Sn | 92% | 99% |
| Sb | 40% | 17% |
| Ba | 35% | 74% |
| Ta | 94% | 100% |
| W | 99% | 98% |
| Tl | 22% | 8% |
| Pb | 22% | 91% |

As shown, efficient removal of metals was observed. For those metals that were not removed, it is believed that metals were also shed by the activated carbon admixed in the PE membrane.

### Example 8: Metal Removal from SC1 (DIW:NH₄OH:H₂O₂ (5:1:1) Applications

This example demonstrates the ability of porous UPE membranes comprising activated carbon to remove target metals from aggressive application such as SC1 under static soaking conditions. Nine target metals from Inorganic Ventures (IV-62491) (Al, Ca, Cr, Cu, Fe, Mn, Ni, Ti, and Zn) were spiked into freshly prepared SC1 solution at 5 ppb concentration of each metal. 47 mm membranes disc were cut and cleaned in 10% HCl/70% IPA for overnight followed by equilibrating with deionized water. The membrane discs were further purified by a freshly prepared SC1 solution and then immersed into the above spiked metal solution for 16 hrs. After 16 hrs, the membrane discs were removed, and the metal removal efficiency was measured by ICP-MS. The results are reported in percent removal in Table 11.

TABLE 11
Percent Removal from SC1

| | Percent Removal |
|---|---|
| Metals | from SC1 solution |
| Al | 0% |
| Ca | 96% |
| Ti | 61% |
| Cr | 0% |
| Mn | 98% |
| Fe | 0% |
| Ni | 97% |
| Cu | 95% |
| Zn | 88% |

### Example 9: Removal of Organic Contaminants from DIW

The following example demonstrates organic impurities removal from DIW. Porous UPE membranes comprising activated carbon were prepared using a method similar to that shown in Example 1 and was then cut into 47 mm membrane discs. The percent removal of organic impurities was determined by immersing the membrane discs into 20 ml DIW solution containing the target impurities, and the removal efficiencies were measured by LC-QToF. The results summarized in Table 12.

TABLE 12
Percent Removal from DIW

| | Activate Carbon | |
|---|---|---|
| Contaminant | in UPE | UPE control |
| N,N-Diisopropylethylamine | 15 | 1 |
| Heptylamine (HA) | 98 | 4 |
| Tetramethylbenzidine (TMB) | 100 | 89 |

Aspects

In a first aspect, a porous polymeric membrane comprises a polymer having admixed therein greater than zero and less than about 80 percent by weight of a carbonaceous material, wherein the membrane exhibits:

(a) a bubble point of about 2 psi to about 200 psi when measured using ethoxy-nonafluorobutane HFE 7200 at a temperature of about 22° C.,

(b) an isopropanol flow time of about 20 seconds/500 ml to about 10,000 seconds/500 ml when measured at 14.2 psi, and

(c) a G25 particle retention of about 25% to about 100%.

A second aspect according to the first aspect is wherein the carbonaceous material is selected from the group consisting of activated carbon, carbon black, carbon nanotubes, and graphene.

A third aspect according to the first or second aspects is wherein the carbonaceous material is in a form of a powder, a particulate material, a fiber, or a sheet.

A fourth aspect according to any of the preceding aspects is wherein the G25 particle retention is about 65% to about 80% at 5% monolayer.

A fifth aspect according to any of the preceding aspects is wherein the membrane exhibits a bubble point of about 10 psi to about 40 psi.

A sixth aspect according to any of the preceding aspects is wherein the membrane exhibits an isopropanol flow time of about 845 seconds/500 ml to about 1665 seconds/500 ml when measured at 14.2 psi.

A seventh aspect according to any of the preceding aspects is wherein the polymer contains less than about 65 μg/g of extractible organic compounds and/or metal ions.

An eighth aspect according to any of the preceding aspects is wherein the polymer is other than a polysulfone or a poly(tetrafluoroethane).

A ninth aspect according to any of the preceding aspects is wherein the polymer has admixed therein about 10 to about 80 percent by weight of the carbonaceous material.

A tenth aspect according to any of the preceding aspects is wherein the membrane has a thickness of about 35 to about 400 μm.

An eleventh aspect according to any of the preceding aspects is wherein the polymer is chosen from the group consisting of polyamides, polyimides, polyolefins, polyether-sulfones, polyacrylates, polyesters, celluloses, cellulose esters, polycarbonates, poly(phenylene oxide), poly(styrene), halogenated polymers, and combinations thereof.

In a twelfth aspect, a filter comprises the porous polymeric membrane of claim 1.

In a thirteenth aspect, a composite membrane comprises a first porous polymeric membrane and a second porous polymeric membrane,

wherein an outer surface of the first porous polymeric membrane is in contact with an outer surface of the second porous polymeric membrane,

wherein the first porous polymeric membrane comprises a first polymer having admixed therein greater than zero and less than about 80 percent by weight of a first carbonaceous material, and

wherein the second porous polymeric membrane is different from the first porous polymeric membrane.

A fourteenth aspect according the thirteenth aspect is wherein the outer surface of the first porous polymeric membrane is an output facing surface and the outer surface of the second porous polymeric membrane is an input facing surface.

A fifteenth aspect according to the thirteenth or fourteenth aspects is wherein the composite membrane is a co-cast membrane of the first porous polymeric membrane and the second porous polymeric membrane.

In a sixteenth aspect, a filter comprises the composite membrane of claim 13.

In a seventeenth aspect, a method for preparing a porous polymeric membrane comprising a polymer having admixed therein a carbonaceous material comprises:

a. combining a carbonaceous material and a flowable form of the polymer, wherein the polymer has been either (i) admixed with an effective amount of at least one solvent and/or dispersant to provide the flowable form; and/or (ii) heated to a temperature sufficient to provide the flowable form;

b. dispersing the carbonaceous material into the polymer, thereby providing a polymer composition having the carbonaceous material admixed therein; and

c. removing the solvent or dispersant when present, and/or cooling the polymer composition to form the porous polymeric membrane.

An eighteenth aspect according to the seventeenth aspect is wherein the polymer is chosen from polyamides, polyimides, polyolefins, polyether-sulfones, polyacrylates, polyesters, celluloses, cellulose esters, polycarbonates, poly(phenylene oxide), poly(styrene), halogenated polymers, or combinations thereof.

A nineteenth aspect according to the seventeenth or eighteenth aspect is wherein the polymer has admixed therein greater than zero and less than about 80 percent by weight of the carbonaceous material.

In a twentieth aspect, a method of removing impurities from a liquid composition comprises:

contacting the liquid composition with a porous polymeric membrane of claim 1, wherein the liquid composition comprises a liquid chemical and one or more impurities, and

forming a purified liquid composition comprising the liquid chemical and a reduced amount of the one or more impurities.

A twenty-first aspect according to the twentieth aspect is wherein the liquid chemical is a ketone or an alcohol.

A twenty-second aspect according to the twentieth or twenty-first aspects is wherein the liquid chemical is an organic material selected from the group consisting of methyl-amyl ketone, ethyl-3-ethoxypropionate, propylene glycol methyl ether (PGME), propylene glycol methylethylacetate (PGMEA), a mixed solution of propylene glycol monomethyl ether (PGME) and PGMEA (such as 7:3), methanol, ethyl acetate, ethyl lactate, n-butyl acetate (nBA), isopropyl alcohol (IPA), 2-ethoxyethyl acetate (2EEA), a xylene, cyclohexanone, methyl isobutyl carbinol (MIBC), methyl isobutyl ketone (MIBK), isoamyl acetate, undecane, and combinations thereof.

A twenty-third aspect according to the twentieth through twenty-second aspects is wherein the liquid chemical is an amine solvent selected from the group consisting of aqueous ammonia, hydroxylamine, monoethanolamine (MEA), triethanolamine (TEA), morpholine, N-methyldiethanolamine (MDEA), N-monomethylethanolamine (MMEA), N-ethylaminoethoxyethanol, 2-(2-aminoethoxy)ethanol), tetraethylammonium hydroxide (TEAH), tetrabutylammonium hydroxide (TBAH), and combinations thereof.

A twenty-fourth aspect according to the twentieth through twenty-third aspects is wherein the liquid chemical is deionized water, hydrogen peroxide, hydrochloric acid, sulfuric acid, or combinations thereof.

A twenty-fifth aspect according to the twentieth through twenty-fourth aspects is wherein the one or more impurities are metal ions, acids, bases, peroxides, or organic contaminants.

A twenty-sixth aspect according to the twentieth through twenty-fifth aspects is wherein the purified liquid composition comprises no less than 99.99 weight percent of the liquid chemical and no more than about 2000 ppb total of the one or more impurities.

A twenty-seventh aspect according to the twentieth through twenty-sixth aspects is wherein the one or more impurities comprise organic amine impurities chosen from triethylamine, N,N-diisopropylamine, heptylamine, and 3,3,5,5-tetramethyl benzylidene.

A twenty-eighth aspect according to the twentieth through twenty-seventh aspects is wherein the one or more impurities comprise metal ions and wherein the purified liquid composition comprises no more than about 12 ppb total of the metal ions.

A twenty-ninth aspect according to the twenty-eighth aspect is wherein the metal ions are chosen from cations of the group consisting of magnesium, aluminum, titanium, vanadium, manganese, nickel, copper, zinc, molybdenum, silver, cadmium, tin, lead and combinations thereof.

In a thirtieth aspect, a purified liquid composition is purified according to the method of claim 20.

What is claimed is:

1. A porous polymeric membrane comprising a polymer having admixed therein greater than zero and less than about 80 percent by weight of a carbonaceous material, wherein the membrane exhibits:
(a) a bubble point of about 2 psi to about 200 psi when measured using ethoxy-nonafluorobutane HFE 7200 at a temperature of about 22° C.,
(b) an isopropanol flow time of about 20 seconds/500 ml to about 10,000 seconds/500 ml when measured at 14.2 psi, and
(c) a G25 particle retention of about 25% to about 100%.

2. The porous polymeric membrane of claim 1, wherein the carbonaceous material is selected from the group consisting of activated carbon, carbon black, carbon nanotubes, and graphene.

3. The porous polymeric membrane of claim 1, wherein the carbonaceous material is in a form of a powder, a particulate material, a fiber, or a sheet.

4. The porous polymeric membrane of claim 1, wherein the G25 particle retention is about 65% to about 80% at 5% monolayer.

5. The porous polymeric membrane of claim 1, wherein the membrane exhibits a bubble point of about 10 psi to about 40 psi.

6. The porous polymeric membrane of claim 1, wherein the membrane exhibits an isopropanol flow time of about 845 seconds/500 ml to about 1665 seconds/500 ml when measured at 14.2 psi.

7. The porous polymeric membrane of claim 1, wherein the polymer contains less than about 65 μg/g of extractible organic compounds and/or metal ions.

8. The porous polymeric membrane of claim 1, wherein the polymer is other than a polysulfone or a poly(tetrafluoroethane).

9. The porous polymeric membrane of claim 1, wherein the polymer has admixed therein about 10 to about 80 percent by weight of the carbonaceous material.

10. The porous polymeric membrane of claim 1, wherein the membrane has a thickness of about 35 to about 400 μm.

11. The porous polymeric membrane of claim 1, wherein the polymer is chosen from the group consisting of polyamides, polyimides, polyolefins, polyether-sulfones, polyacrylates, polyesters, celluloses, cellulose esters, polycarbonates, poly(phenylene oxide), poly(styrene), halogenated polymers, and combinations thereof.

12. A filter comprising the porous polymeric membrane of claim 1.

13. A composite membrane comprising a first porous polymeric membrane and a second porous polymeric membrane,
wherein an outer surface of the first porous polymeric membrane is in contact with an outer surface of the second porous polymeric membrane,
wherein the first porous polymeric membrane comprises a first polymer having admixed therein greater than zero and less than about 80 percent by weight of a first carbonaceous material, and
wherein the second porous polymeric membrane is different from the first porous polymeric membrane.

14. The composite membrane of claim 13, wherein the outer surface of the first porous polymeric membrane is an output facing surface and the outer surface of the second porous polymeric membrane is an input facing surface.

15. The composite membrane of claim 13, wherein the composite membrane is a co-cast membrane of the first porous polymeric membrane and the second porous polymeric membrane.

16. A filter comprising the composite membrane of claim 13.

17. A method for preparing a porous polymeric membrane comprising a polymer having admixed therein a carbonaceous material, the method comprising:
a. combining a carbonaceous material and a flowable form of the polymer, wherein the polymer has been either (i) admixed with an effective amount of at least one solvent and/or dispersant to provide the flowable form; and/or (ii) heated to a temperature sufficient to provide the flowable form;
b. dispersing the carbonaceous material into the polymer, thereby providing a polymer composition having the carbonaceous material admixed therein; and
c. removing the solvent or dispersant when present, and/or cooling the polymer composition to form the porous polymeric membrane.

18. The method of claim 17, wherein the polymer is chosen from polyamides, polyimides, polyolefins, polyether-sulfones, polyacrylates, polyesters, celluloses, cellulose esters, polycarbonates, poly(phenylene oxide), poly(styrene), halogenated polymers, or combinations thereof.

19. The method of claim 17, wherein the polymer has admixed therein greater than zero and less than about 80 percent by weight of the carbonaceous material.

20. A method of removing impurities from a liquid composition, the method comprising:
contacting the liquid composition with a porous polymeric membrane of claim 1, wherein the liquid composition comprises a liquid chemical and one or more impurities, and
forming a purified liquid composition comprising the liquid chemical and a reduced amount of the one or more impurities.

21. The method of claim 20, wherein the liquid chemical is a ketone or an alcohol.

22. The method of claim 20, wherein the liquid chemical is an organic material selected from the group consisting of methyl-amyl ketone, ethyl-3-ethoxypropionate, propylene glycol methyl ether (PGME), propylene glycol methylethylacetate (PGMEA), a mixed solution of propylene glycol monomethyl ether (PGME) and PGMEA (such as 7:3), methanol, ethyl acetate, ethyl lactate, n-butyl acetate (nBA), isopropyl alcohol (IPA), 2-ethoxyethyl acetate (2EEA), a xylene, cyclohexanone, methyl isobutyl carbinol (MIBC), methyl isobutyl ketone (MIBK), isoamyl acetate, undecane, and combinations thereof.

23. The method of claim 20, wherein the liquid chemical is an amine solvent selected from the group consisting of aqueous ammonia, hydroxylamine, monoethanolamine (MEA), triethanolamine (TEA), morpholine, N-methyldiethanolamine (MDEA), N-monomethylethanolamine (MMEA), N-ethylaminoethoxyethanol, 2-(2-aminoethoxy)ethanol), tetraethylammonium hydroxide (TEAH), tetrabutylammonium hydroxide (TBAH), and combinations thereof.

24. The method of claim 20, wherein the liquid chemical is deionized water, hydrogen peroxide, hydrochloric acid, sulfuric acid, or combinations thereof.

25. The method of claim 20, wherein the one or more impurities are metal ions, acids, bases, peroxides, or organic contaminants.

26. The method of claim 20, wherein the purified liquid composition comprises no less than 99.99 weight percent of the liquid chemical and no more than about 2000 ppb total of the one or more impurities.

27. The method of claim 20, wherein the one or more impurities comprise organic amine impurities chosen from triethylamine, N,N-diisopropylamine, heptylamine, and 3,3,5,5-tetramethyl benzylidene.

28. The method of claim 20, wherein the one or more impurities comprise metal ions and wherein the purified liquid composition comprises no more than about 12 ppb total of the metal ions.

29. The method of claim 28, wherein the metal ions are chosen from cations of the group consisting of magnesium, aluminum, titanium, vanadium, manganese, nickel, copper, zinc, molybdenum, silver, cadmium, tin, lead and combinations thereof.

30. A purified liquid composition purified according to the method of claim 20.
